(19) United States
(12) Patent Application Publication
(10) Pub. No.: US 2024/0246864 A1
(43) Pub. Date: Jul. 25, 2024

(54) NANO ZIRCONIA SUSPENSIONS AND RESULTING CERAMIC BODIES

(71) Applicant: James R. Glidewell Dental Ceramics, Inc., Newport Beach, CA (US)

(72) Inventors: Sai Sumant Kalidindi, Irvine, CA (US); Sreeram Balasubramanian, Irvine, CA (US); Dimple Pradhan, Irvine, CA (US); Dongkyu Kim, Irvine, CA (US); Yan Yang, Irvine, CA (US)

(73) Assignee: James R. Glidewell Dental Ceramics, Inc., Newport Beach, CA (US)

(21) Appl. No.: 18/421,252

(22) Filed: Jan. 24, 2024

Related U.S. Application Data
(60) Provisional application No. 63/481,248, filed on Jan. 24, 2023.

(51) Int. Cl. C04B 35/486; A61C 13/00; A61C 13/08; C04B 35/626; C04B 35/64

(52) U.S. Cl. CPC C04B 35/486; A61C 13/0022; A61C 13/081; C04B 35/6263; C04B 35/64; C04B 2235/3225; C04B 2235/3246; C04B 2235/5454; C04B 2235/6027; C04B 2235/785; C04B 2235/9646

(57) ABSTRACT

A zirconia body includes a sintered yttria-stabilized zirconia ceramic material, stabilized by 3 mol % to 4.8 mol % yttria, wherein the sintered ceramic material has an opacity of 52% to 65% (when measured on a 1 mm thick fully sintered ceramic body), an average grain size of less than 175 nm, a fracture toughness greater than 2.5 MPa·m^{1/2}, and a millability number<75.

This application claims the benefit of and priority to U.S. Provisional Patent Application No. 63/481,248, filed Jan. 24, 2023, which is incorporated herein by reference in its entirety.

### BACKGROUND

Ceramic materials, and particularly yttria-stabilized zirconia (YSZ), have been widely adopted for use in dental restorations because these materials have high strength and high fracture toughness. Conventional methods of manufacturing dental ceramic materials include molding a mixture of starting materials that includes yttria-stabilized zirconia powder into a green body, typically by press molding methods such as uniaxial pressing or cold isostatic pressing (CIP).

### SUMMARY

Disclosed herein is a material comprising:

a sintered yttria-stabilized zirconia ceramic, stabilized by 3 mol % to 4.8 mol % yttria, wherein the sintered ceramic has an opacity of 52% to 65% (when measured on a 1 mm thick fully sintered ceramic body), an average grain size of less than 175 nm, a fracture toughness greater than 2.5 MPa·m^{1/2} and a millability number<75.

Also disclosed herein is a method comprising:

concentrating an initial nano zirconia aqueous suspension resulting in a first intermediate nano zirconia aqueous suspension having a higher viscosity and solids content relative to the initial nano zirconia aqueous suspension:

lowering the viscosity of the first intermediate nano zirconia aqueous suspension, while maintaining the solids content, resulting in a second intermediate nano zirconia aqueous suspension having a lower viscosity relative to the first intermediate nano zirconia aqueous suspension; and casting the second intermediate nano zirconia aqueous suspension that comprises allowing the second intermediate nano zirconia aqueous suspension to increase in viscosity and drying the nano zirconia aqueous suspension under ambient conditions resulting in a green state body,

wherein the method does not include adding a pH modifier, or wherein the method does not include adding an anionic dispersant.

Further disclosed herein is a method comprising:

concentrating an initial nano zirconia aqueous suspension resulting in a first intermediate nano zirconia aqueous suspension having a higher viscosity and solids content relative to the initial nano zirconia aqueous suspension, wherein the first intermediate nano zirconia aqueous suspension has a solids content of 68 to 72% solids and a viscosity of over 8000 cP:

lowering the viscosity of the first intermediate nano zirconia aqueous suspension, while maintaining the solids content, resulting in a second intermediate nano zirconia aqueous suspension having a lower viscosity relative to the first intermediate nano zirconia aqueous suspension wherein the second intermediate nano zirconia aqueous suspension has a solids content of 68 to 72% solids and a viscosity of 100 to 300 cP; and casting the second intermediate nano zirconia aqueous suspension that comprises allowing the second intermediate nano zirconia aqueous suspension to reach a viscosity of over 8000 cp wherein the cast part can support its own weight without deformation at ambient conditions, and drying the nano zirconia aqueous suspension under ambient conditions resulting in a green state body, wherein the green state body has a green density of >53% and median pore size of less than 10 nm, and wherein each of the initial nano zirconia suspension, the first intermediate nano zirconia suspension, and the second intermediate nano zirconia suspension comprises yttria-stabilized particles having a particle size distribution at D₍₅₀₎ of less than 50 nm.

The foregoing will become more apparent from the following detailed description, which proceeds with reference to the accompanying figures.

### BRIEF DESCRIPTION OF THE DRAWINGS

FIG. 1 is a process flowchart of certain embodiments disclosed herein.

FIG. 2 is translucency spectra green sample made from suspension E13.

FIG. 3. shows molds (upper three images) and nano parts made from them (lower three images).

FIG. 4. shows transparent green parts made from nano precursor E13.

FIG. 5. is a plot of opacity and millability number of the examples.

FIG. 6 shows the SEM micrograph of E6.7.

FIG. 7. shows an example of particle size distribution of embodiments.

### DETAILED DESCRIPTION

Disclosed herein are unique nano zirconia aqueous suspensions having properties that aid in quick casting and enhanced mechanical and esthetic properties of ceramic bodies made and sintered from the suspensions. In particular, the suspensions disclosed herein exhibit reversible viscosity behavior. Initially concentrating a starting suspension produces a very viscous (more viscous than honey, e.g., viscosity of 8200 cp) suspension. Subsequent ultrasonication of the suspension renders the suspension very fluid. The ultrasonication helps to remove trapped air bubbles and improves pourability of the suspension, which is desirable for filling a mold shape. Once a mold is filled with the suspension, the suspension rethickens to a viscous consistency, enabling consolidation and locking of green microstructure of a resulting ceramic body.

Concentrating the suspension reduces water content thereby accelerating casting and drying times. This approach solves high casting and drying times associated with nano zirconia aqueous suspensions. In addition, the resulting green state body exhibits reduced cracking. In certain embodiments, sintered bodies made from the processes disclosed herein achieve high light translucency in low yttria concentration samples.

The nano zirconia aqueous suspension utilized herein are aqueous suspensions of yttria-stabilized zirconia particles having a measured median particle size, or particle size distribution at D₍₅₀₎ of less than 100 nm, or less than 50 nm, or less than 30 nm. As used herein, the term “measured particle size” refers to measurements obtained by a Brookhaven Instruments Corp. X-ray disk centrifuge analyzer. Stabilized zirconia ceramic material includes both fully and partially stabilized zirconia. Zirconia may be stabilized with approximately 1 mol % to approximately 8 mol % yttria, or approximately 2 mol % to approximately 6 mol % yttria, or approximately 2 mol % to approximately 6.5 mol % yttria, or approximately 2 mol % to approximately 5.5 mol % yttria, or approximately 2 mol % to approximately 5 mol % yttria, or approximately 2 mol % to approximately 4 mol % yttria. Yttria-stabilized zirconia ceramic materials in the suspension may comprise up to 7.5 mol % yttria, or up to 8.5 mol % yttria, for example, from 5 mol % yttria to 8.5 mol % yttria, from 5 mol % yttria to 8 mol % yttria, from 5 mol % yttria to 7.5 mol % yttria, 5 mol % yttria to 6.4 mol % yttria, from 5 mol % yttria to 5.6 mol % yttria, from 5.1 mol % yttria to 6.4 mol % yttria, from 5.2 mol % yttria to 7.5 mol % yttria, from 5.2 mol % yttria to 7.0 mol % yttria, from 5.4 mol % yttria to 7.5 mol % yttria, from 5.4 mol % yttria to 7.0 mol % yttria, from 5.5 mol % yttria to 7.5 mol % yttria, from 5.5 mol % yttria to 7 mol % yttria, from 5.5 mol % yttria to 6.9 mol % yttria, from 5.5 mol % yttria to 6 mol % yttria, from 5.5 mol % yttria to 5.9 mol % yttria, from 5.6 mol % yttria to 6.3 mol % yttria, from 5.7 mol % yttria to 6.3 mol % yttria, from 5.8 mol % yttria to 6.3 mol % yttria, from 6 mol % yttria to 8.5 mol % yttria, from 6 mol % yttria to 8 mol % yttria, from 6.0 mol % yttria to 7.5 mol % yttria, from 6 mol % yttria to 7 mol % yttria, from 6.0 mol % yttria to 6.8 mol % yttria, from 6.0 mol % yttria to 6.3 mol % yttria, from 6.2 mol % yttria to 7.5 mol % yttria, from 6.4 mol % yttria to 7.5 mol % yttria, from 7 mol % yttria to 8.5 mol % yttria, or from 7.2 mol % to 8.4 mol % yttria, to stabilize zirconia.

Yttria-stabilized zirconia ceramic materials used as starting materials in the suspension may, optionally, include a small amount of alumina (aluminum oxide, Al₂O₃) as an additive. For example, some commercially available yttria-stabilized zirconia ceramic material include alumina at concentrations of from 0 wt % to 2 wt %, or from 0 wt % to 0.25 wt %, such as 0.1 wt %, relative to the zirconia material. Other optional additives of the ceramic starting material may include coloring agents to obtain shaded zirconia ceramic powder that may be formed by, for example, casting into shaded ceramic blocks that have a dentally acceptable shade or pre-shade upon sintering.

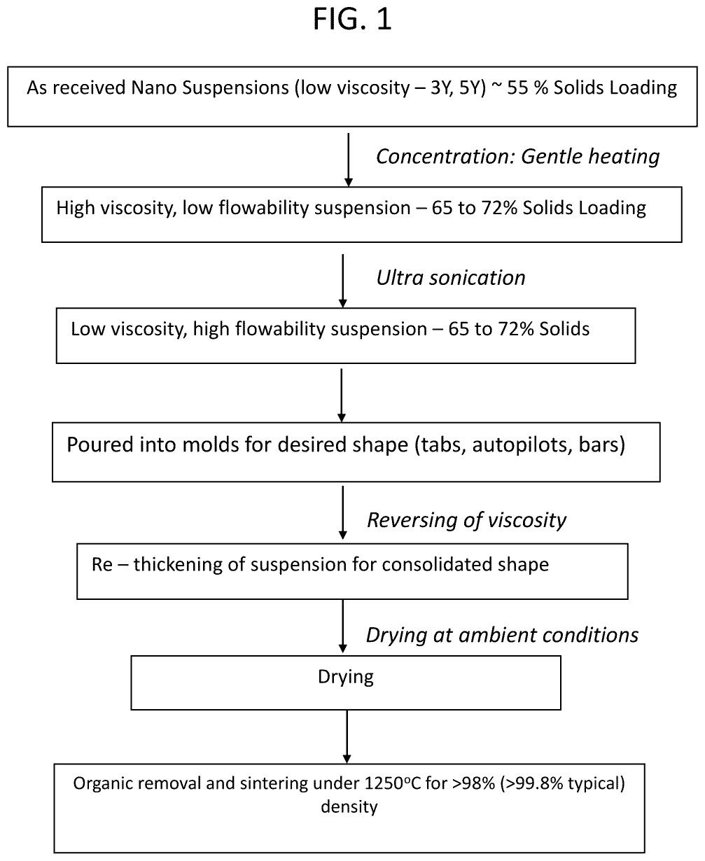

In general, the processes disclosed herein involve concentrating an initial nano zirconia aqueous suspension resulting in a first intermediate nano zirconia aqueous suspension having a higher viscosity and solids content relative to the initial nano zirconia aqueous suspension, lowering the viscosity of the first intermediate nano zirconia aqueous suspension, while maintaining the solids content, resulting in a second intermediate nano zirconia aqueous suspension having a lower viscosity relative to the first intermediate nano zirconia aqueous suspension, casting the second intermediate nano zirconia aqueous suspension that comprises allowing the second intermediate nano zirconia aqueous suspension to increase in viscosity and drying the nano zirconia aqueous suspension under ambient conditions resulting in a green state body, milling the green state body, and sintering the milled green state body resulting in a ceramic body that can be milled or machined into a dental prostheses. A flowchart for an embodiment of the process is shown in FIG. 1.

In certain embodiments, the process does not include the use of a pH modifier and/or a dispersant (e.g., an anionic dispersant).

In certain embodiments, the zirconia particles in the suspension (including the initial suspension, the first intermediate suspension, and the second intermediate suspension) maintain a measured median particle size, or particle size distribution at D₍₅₀₎ of less than 30 nm post-initial concentration and post-ultrasonication.

The initial nano yttria stabilized zirconia aqueous suspension can include 2.0 mole % to 8.0 mole %, or 2 to 6 mol %, or 3 to 5 mol % yttria. In certain embodiments the initial nano aqueous suspension can include zirconia and yttria mixed in the above ratios.

The initial nano zirconia aqueous suspension can have a solids content of 5 wt % to 75 wt %, or 20 wt % to 65 wt %, or 50 wt % to 57 wt %.

The initial nano zirconia aqueous suspension can have a viscosity of 5 to 100 cP, or 10 to 80 cP, or 20 to 50 cP.

In certain embodiments, the yttria-stabilized zirconia particles in the initial nano zirconia aqueous suspension have a measured median particle size, or particle size distribution at D₍₅₀₎ of less than 100 nm, or less than 50 nm, or less than 30 nm. As used herein, the term “measured particle size” refers to measurements obtained by a Brookhaven Instruments Corp.

X-ray disk centrifuge analyzer.

In certain embodiments, the initial nano zirconia aqueous suspension has a yttria concentration of 3 to 4.5 mol %, a solids content of 55 to 57%, and a viscosity of 10 to 50 cP.

In certain embodiments, the initial nano zirconia aqueous suspensions are commercially available from Luxfer MEL Technologies.

In certain embodiments, concentrating the initial nano zirconia aqueous suspension includes sufficient heating of the suspension until a desired viscosity is reached for the first intermediate nano zirconia aqueous suspension. The suspension may be heated at ambient pressure at 30° C. to 100° C., or 50 to 90° C., or 75 to 85° C. for 30 min to 1200 min or, 60 minutes to 600 minutes, or 120 minutes to 300 minutes.

The first intermediate nano zirconia aqueous suspension can have a solids content of 60 to 75%, or 62 to 72%, or 68 to 71%.

The first intermediate nano zirconia aqueous suspension can reach a viscosity of over 1000 cP, or over 10,000 cP, or over 50,000 cP, or 200,000 to 250,000 cP, or even higher viscosities that may not be measurable.

In certain embodiments, the first intermediate nano zirconia aqueous suspension has a solids content of 68 to 72%, and a viscosity of 150,000 to 250,000 cP.

In certain embodiments, the yttria-stabilized zirconia particles in the first intermediate nano zirconia aqueous suspension have a measured median particle size, or particle size distribution at D₍₅₀₎ of 10 to 100 nm, or 12 to 50 nm, or 15 to 30 nm.

In certain embodiments, lowering the viscosity of the first intermediate nano zirconia aqueous suspension includes ultrasonication of the first intermediate nano zirconia aqueous suspension. In certain embodiments, the ultrasonic sound waves may have a frequency of 20 kHZ. The ultrasonication may be conducted for up to 150 see for 100 g of suspension with intermittent cooldown to less than 25° C. in an ice bath after every 30 see of ultrasonication.

The second intermediate nano zirconia aqueous suspension can have a solids content of 60% to 75%, or 62% to 72%, or 68% to 71%.

The second intermediate nano zirconia aqueous suspension can have a viscosity of 10 to 500 cP or 20 to 300 cP, or 100 to 200 cP.

In certain embodiments, the yttria-stabilized zirconia particles in the second intermediate nano zirconia aqueous suspension have a measured median particle size, or particle size distribution at D₍₅₀₎ of 10 to 100 nm, or 20 to 70 nm, or 30 to 50 nm

In certain embodiments, the second intermediate nano zirconia aqueous suspension has a solids content of 68 to 72%, and viscosity of 100 to 250 cP.

The second intermediate nano zirconia aqueous suspension can be cast such that the viscosity of the suspension reverses meaning that the suspension re-thickens. In certain embodiments, the suspension undergoing casting forms a gel. The second intermediate nano zirconia aqueous suspension can be introduced into a mold via any technique. For example, pouring the second intermediate nano zirconia aqueous suspension into a mold is convenient since the second intermediate nano zirconia aqueous suspension exhibits superior pourability due to its low viscosity for an adequate working period of at least 30 minutes before it increases in viscosity. Alternately the second intermediate nano zirconia aqueous suspension could be filled into a syringe or similar injecting apparatus and be injected into the mold.

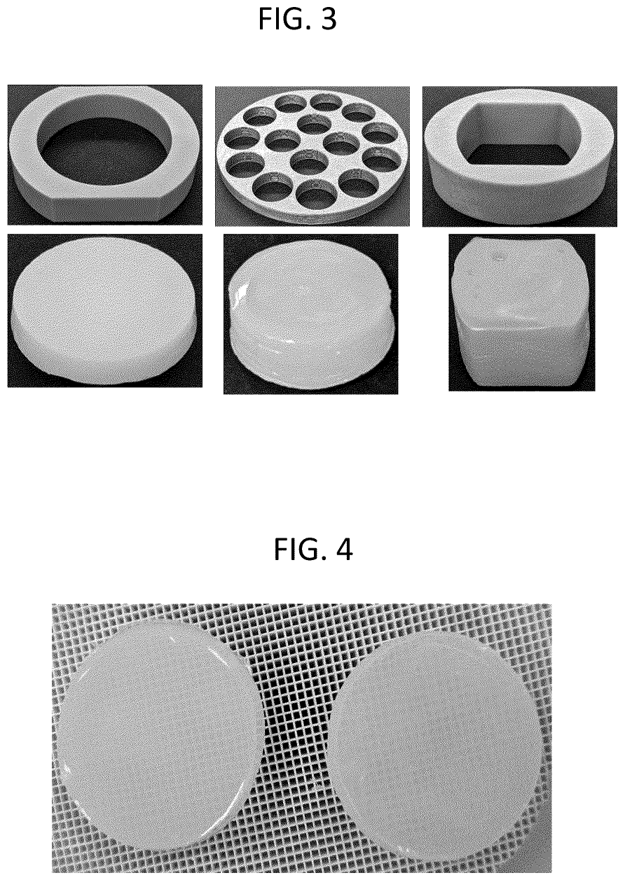

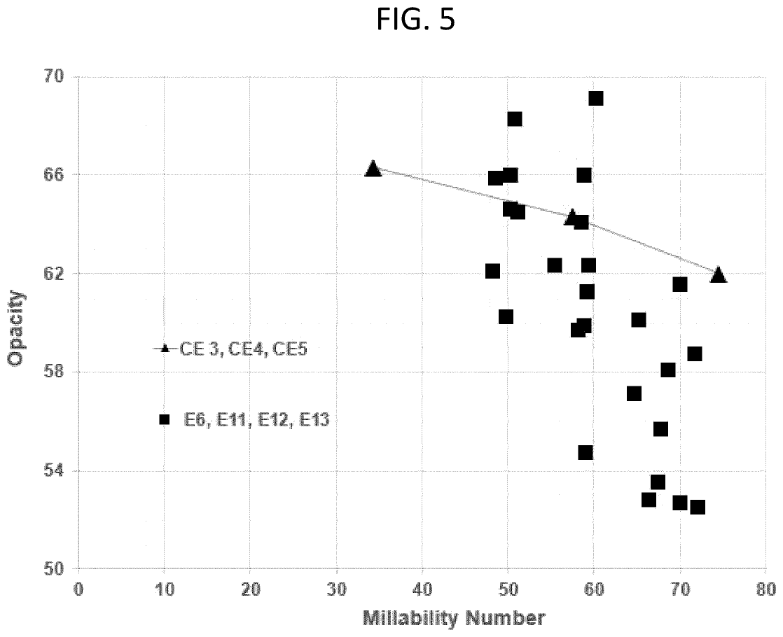

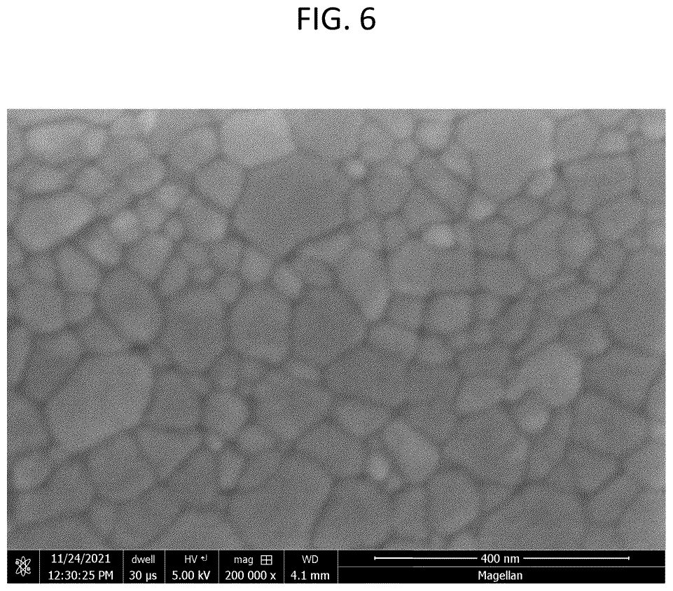

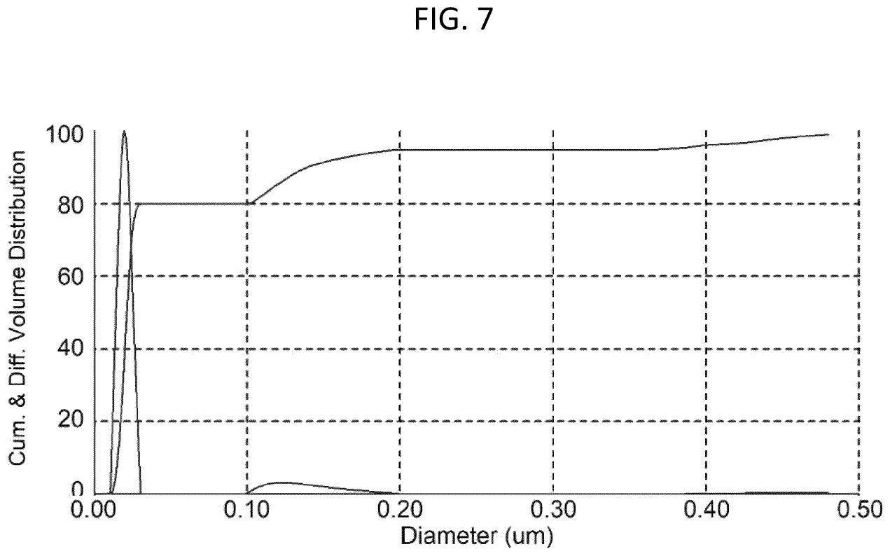

As the second intermediate nano zirconia aqueous suspension resides in the mold the viscosity of the suspension reverses meaning that the suspension re-thickens. For example, the suspension in the mold may reach viscosity of over 5000 cP, such as over 10,000 cP or over 200,000 cP after at least 60 minutes in the mold. The mold may be a porous mold (e.g., plaster of Paris or other porous/filtration media). The mold could also be nonporous mold such as Teflon or any commonly used material like plastic or stainless steel. For example, the mold could be a combination of a porous base and a nonporous material such as plastic that sits on the porous base and holds the poured suspensions in place. The mold may be a desired shape for producing a dental ceramic. For example, the mold may be a cylinder, a bar or other irregular shape. Some examples of molds used for casting and parts made from them are shown in FIG. 3 and FIG. 4.

Water contained in the suspension may be absorbed/filtered through the porous media. Bodies set in the mold may be allowed to dry another 1 to 3 days in the mold under ambient pressure at 15-30° C. to have a remnant moisture content of 5 to 25% or 10 to 20%. At this point, the bodies may be optionally removed from the mold and kept to dry under ambient room conditions 15 to 30° C. till the weight stabilizes at atmospheric pressure resulting in a consolidated, green stage body. In certain embodiments, the drying time is at least 1 day, or at least 2 days, or at least 6 days. In certain embodiments, the drying does not require any specialized drying equipment since it can be performed under ambient room conditions. In certain embodiments, the drying can be performed under atmospheric pressure at 40-80° C. or 40-60° C. for 1-2 days.

The green stage body can be any desired shape such as a solid block, disk, near net shape, or other regular or irregular shapes. In certain embodiments, the second intermediate nano zirconia aqueous suspension exhibits an accelerated setting process that does not require a centrifuge. The green stage body can serve as a dental milling blank as a solid block, disk or near-net-shape, having dimensions suitable for use in milling or grinding into any desired dental shape such as, for example, single unit or multi-unit restorations, such as crowns, veneers, bridges, partial or full-arch dentures, and the like. In certain embodiments, green stage bodies are shaped via milling into near-net-shape blocks having generic sizes and shapes that are sintered to theoretical density prior to machining into a final patient-specific dental restoration. The sintered near-net-shape bodies may be prepared having a shape and/or size that is suitable for range of similarly sized and shaped final restoration products. Examples of suitable shaped forms which may be sintered to full theoretical density prior to shaping may be found in commonly owned U.S. Patent Publication No. 2013/0316305, and U.S. Pat. No. D769,449, both of which are hereby incorporated herein in their entirety.

The processes described herein may provide green bodies having relative densities PR greater than 52%, such as from 53% to 56% relative density, or such as from 54% to 55% relative density. As used herein, the term “relative density” (β_{R}) refers to the ratio of the measured density ρ_{M} of a sample (g/cm³) to the theoretical density ρ_{T} (3 YSZ-6.083 g/mL: 5 YSZ-6.037 g/mL: 7 YSZ-5.991 g/mL).

The processes described herein may provide green bodies having a porosity of at least 48 vol % porosity, or at least 44 vol % porosity. In certain embodiments, the green stage bodies have a porosity of 44 to 47 vol % porosity, or 45 to 46 vol % porosity. As used herein, the term “porosity”, expressed as percent porosity above, is calculated as: percent porosity=1-percent relative density.

In some embodiments, the median pore size of green bodies is less than 50 nm, or less than 20 nm, less than 10 nm, such as from 2 nm to 30 nm, or from 2 nm to 20 nm, or from 3 nm to 6 nm, when measured according to the methods described herein. As used herein, the term “median pore diameter” refers to the volume-based pore diameter measurements obtained from a bisqued body via mercury intrusion performed with an Autopore V porosimeter from Micromeritics Instrument Corp.

In certain embodiments the green stage body may be subjected to further volatile substance removal by slowly heating to a temperature of 300 to 600° C. and holding for 2-4 hours.

After green stage milling, the green stage body can be sintered. The green stage body may be “fully sintered” under atmospheric pressure to a density that is at least 98% of the theoretical density of a sintered body. Sintering may occur at oven temperatures in the range of 950° C. to 1250° C., or 1050° C. to 1200° C., or 1100° C. to 1150° C. Hold times (dwell times) at a temperature within a sintering temperature range may be from 5 minute to 40 hours, such as from 30 minutes to 20 hours, or from 30 minutes to 2 hours, or from 2 hour to 20 hours, or from 5 hour to 15 hours, or from 7 hours to 10 hours. Other sintering processes include multi-step sintering processes described in commonly owned U.S. Pat. Pub. 2019/0127284, filed Oct. 31, 2018, hereby incorporated herein by reference in its entirety. Multi-step sintering processes may comprise one or more temperature gradients within a sintering temperature range, with each gradient having the same or different ramp rates, reaching oven temperatures at or above 1000° C., such as from 900° C. to 1250° C., or 1050° C. to 1200° C., or 1100° C. to 1150° C. Multi-step sintering methods may optionally having no hold time within a sintering temperature range, or one hold time or multiple hold times at or above 950° C. Multi-step sintering processes may have multiple temperature peaks at or above 950° C., and at least one temperature steps that is between 1000° C. to 1300° C. lower, or between 50° C. to 300° C. lower, than a preceding or subsequent temperature peak. Hold times at temperature peaks may be between 2 minutes and 60 minutes, and a lower temperature step between two temperature peaks may have a hold time between 30 minutes and 40 hours. In certain embodiments, a sintered dental body having a relative density of greater than 98%, more particularly greater than 99.8%, is achievable even with a sintering temperature of less than 1250° C.

In certain embodiments, the millable or machinable sintered bodies have a fracture toughness greater than 2.8 MPa·m^{1/2}, or greater than 3.5 MPa·m^{1/2}, or greater than 4 MPa·m^{1/2} when tested according to the method described herein.

In certain embodiments, the sintered bodies have an opacity of less than 66%, or less than 64%, or less than 62% or less than 55% when measured on a 1 mm thick sintered body. In certain embodiments, the sintered bodies have an opacity value of between 60% and 65% transmittance, or between 50% and 58%, or 52% and 55% when measured on a 1 mm thick sintered body.

In certain embodiments, the sintered bodies have an average grain size of less than 200 μm, or less than 150 μm, or less than 120 μm, when measured according to methods described herein.

In certain embodiments, the sintered bodies have a hardness value of less than or equal to 14, or 12 to 14, or 13 to 13.8, GPa, when tested by the method described herein.

In certain embodiments, the sintered bodies having relative densities ρ_{T} greater than 98%, such as from 99.50% to 99.99% relative density, or such as from 99.80% to 99.90% relative density. As used herein, the term “relative density” (β_{R}) refers to the ratio of the measured density PM of a sample (g/cm³) to the theoretical density ρ_{T} (3 YSZ-6.083 g/mL: 5 YSZ-6.037 g/mL: 7 YSZ-5.991 g/mL).

After sintering, the sintered bodies can be machined into a final patient-specific dental prostheses. The dental prostheses may be shaped into a crown, a multi-unit bridge, an inlay or onlay, a veneer, a full or partial denture, or other dental prosthesis.

In certain embodiments, the sintered body may be provided in the shape of a cylinder or cuboid block that may be loaded into a mill with an option holder for attachment and milled chairside in a dental office to generate a dental article such as a crown, bridge, veneer, inlay or onlay that may be seated onto a patient.

### EXAMPLES

### Examples 1-13

Nano yttria stabilized zirconia suspensions containing 3 and 4.5 mol % yttria and having a solid loading of 56 wt % were obtained from Luxfer MEL Technologies (Manchester, United Kingdom), were used as received. No additional chemicals such as pH modifiers or dispersing agents were used. Based on the final yttria content targeted, total 100 g of the 3Y and 4.5Y nano-suspensions, in appropriate ratios, were mixed on a hot plate (Corning PC-620D Stirring Hot Plate), for 7 min at 260 rpm without heating to make suspensions at intermediate yttria contents. These were then concentrated by slow evaporation of 50-100 g of the nano suspension or mixed suspensions on a hot plate set at ˜80° C. by stirring at ˜60 rpm with a magnetic stirrer for over 1 hour till the target solid loading was achieved. Once the desired solid loading was reached, the vessel containing the concentrated nano-suspension was placed in an ice bath to stop further concentration. In some cases the cooled nano-suspension was then ultra-sonicated by placing in an ice-water bath maintained at <15° C. The suspensions were ultrasonicated (Sonics Vibra Cell VCX 750) with power of 750 watt and frequency of 20 kHz by using 1″ tip diameter probe at an amplitude of 35 micron in increments of 30 see to cool down to <25° C. as needed. 30-50 g batch was ultra-sonicated for 60 see total and 80-100 g batches was ultra-sonicated for 150 see total.

After the ultra-sonication, the nano suspension was poured into a large disc mold with a cardboard substrate as a base. The large disc mold contained 15 smaller disc molds with each having a dimension of diameter: 19.5 mm and height of 7.3 mm. The setup was then placed in a closed table drawer with restricted air flow to start the drying and re-gelling process. After 2 days, the samples were leather hard and shrunk enough from the setup and were de-molded. The de-molded samples were left in the closed table drawer for another 2 days to continue the drying. The samples were then removed from the table drawer and left on the table-top in ambient conditions for another 2 days. On the 7th day, the samples were ground and polished in green stage for characterization and sintering.

Select samples were subjected to removal of volatiles by loading in air fired furnace and heating at a rate of 0.1° C./min to a peak temperature 350 deg C. and hold of 2 hr with intermittent 2 hr holds at 150, 250, 300° C.

Samples were then sintered by heating at a rate of 1° C./min in an air fired furnace to the peak temperature and by holding for a time shown in the tables.

### Comparative Examples (CE1 and CE2)

22.8 g of 2-[2-(2-Methoxyethoxy)ethoxy]acetic acid (Sigma Aldrich), 2 wt % to weight of ZrO₂ solids, was added into 2000 g of 3Y Nano slurry (Luxfer MEL Technologies) used in examples, and the mixture was stirred at 60° C. for 1 hr. 2000 g of mixed slurry was attrition milled using horizontal bead mill (Labstar 993-06, Netzsch, Selb, Germany) with 0.05 mm ZrO₂ balls at 3000 rpm for 1 hr 45 min. 1 wt % (to weight of ZrO₂ solids) of polyethylene glycol (molecular weight: 20,000) was added into the final milled slurry. 1000 g of “20 wt % PEG (molecular weight: 35000) -80 wt % H₂O solution” was made and the solution was put into 3000 ml container. 50˜200 g of suspension was poured into a dialysis semipermeable membrane tubing [Spectra/Par dialysis membrane MWCO 6000-8000, tubing flat width 50 mm]. ⅓˜¼ of the tubing was unfilled and two ends of the tubing were closed by using two clip closures.

The membrane tubing was placed into the “20 wt % PEG-80 wt % H₂O solution”. The container having “membrane tubing” and “20 wt % PEG-80 wt % H₂O solution” was placed on a shaking table, and was continuously shaken at 125 rpm for 24 hr. The obtained gel is translucent and very soft, with 76 wt % (34.2 vol %) solid loading.

Further homogenization of the gel was obtained by rotating in Planetary Mixer at 1000 rpm for 60 sec. About 30˜60 g of ZrO₂ gel was poured into PTFE mold with diameter of 30 mm and height of 35 mm. The loaded PTFE mold was placed in a centrifugal machine (Legend XT by Thermo Scientific) and centrifugal cast was conducted at 4300 rpm for 5 min. The mold was then put into environmental chamber for drying with the cycle of at humidity of 85% and temperature of 25° C. for 4 days 4 hours, and at humidity of 65% and temperature of 25° C. for 2 days 8 hours, and at humidity of 45% and temperature of 25° C. for 2 day 8 hour, and then at humidity of 20% and temperature of 25° C. for 2 day 8 hour. The dried sample was heat treated to remove binder with the cycle of 0.1° C./min to 240° C. and 0.5° C./min to 650° C., and then maintained at 650° C. for 2 hr. The binder removed sample was then sintered at 1100° C. for 2 hr after heating with the rate of 5° C./min.

### Comparative Example (CE3, CE4, CE5)

Commercially available yttria stabilized zirconia powders from Tosoh Corporation (Tokyo, Japan) were pressed in a uniaxial die to a diameter of ˜100 mm and thickness of 16 mm (CE3-Zpex, 3.17 g/cc, CE4-Zpex 4, 3.21 g/cc, CE 5-Zpex Smile, 3.21 g/cc). These were then subjected to an organic removal by heating at a rate as follows—0.1 deg/min to 400° C. and then at 1° C./min to 950° C., with 2 hr holds at 150, 250 and 400° C. and 4 hr hold at 950° C. Discs were then machined out of these and then sintered to the peak temperature shown in Table by heating as follows 15° C./min to 1200° C., hold at 1200° C. for 1 hr, 2° C./min to 1300° C., 10 5° C./min to peak temperature.

The details and data for the example suspensions and comparative examples are shown below in Tables 1-5.

TABLE 1
Details of Suspensions

| Sam- | | | | | |
|---|---|---|---|---|---|
| ple | Yttria | | | | Solid |
| num- | mol | | initial | | load- |
| ber | % | Notes/type | weight | Concentration conditions | ing |
| CE1 | 3 | as received | | | 56.0 |
| E1 | 3 | conc. only | 50 | 60 rpm, 80 C., 1 h 28 min | 65.2 |
| E2 | 3 | conc. only | 100 | | 68.3 |
| E3 | 3 | conc. only | 100 | 60 rpm, 80 C., 3 h 35 min | 70.1 |
| E4 | 3 | conc. only | 50 | 60 rpm, 80 C., 1 h 55 min | 70.3 |
| E5 | 3 | conc. only | 50 | 60 rpm, 80 C., 2 h 9 min | 75.1 |
| E6 | 3 | conc. + US | 100 | 60 rpm, 80 C., 4 h 7 min | 69.9 |
| E7 | 3 | conc. + US | | | 60.0 |
| E8 | 3 | conc. + US | 50 | 60 rpm, 80 C., 1 h 28 min | 65.2 |
| E9 | 3 | conc. + US | 100 | | 68.3 |
| E10 | 3 | conc. + US | 50 | 60 rpm, 80 C., 1 h 55 min | 70.3 |
| E11 | 3.5 | conc. + US | 100 | 60 rpm, 80 C., 3 h 52 min | 70.0 |
| E12 | 4 | conc. + US | 100 | 60 rpm, 80 C., 4 h 35 min | 70.0 |
| E13 | 4.5 | conc. + US | | | 70.2 |
| CE2 | 3 | conc. by | | | 76.0 |
| | | osmosis | | | |

TABLE 2
Viscosity and Particle Size Distribution

| Sample | | Solid | | | | | |
|---|---|---|---|---|---|---|---|
| number | Notes/type | loading | viscosity | D10 | D50 | D90 | D99 |
| CE1 | as received | 56.0 | 20 | 15 | 21 | 133 | 531 |
| E2 | conc. only | 68.3 | Not mea- | 18 | 24 | 150 | 433 |
| | | | surable | | | | |
| | | | (>200000) | | | | |
| E3 | conc. only | 70.1 | 214160 | | | | |
| E4 | conc. only | 70.3 | 237925 | | | | |
| E5 | conc. only | 75.1 | Not mea- | | | | |
| | | | surable | | | | |
| | | | (>200000) | | | | |
| E8 | conc. + US | 65.2 | 33 | | | | |
| E9 | conc. + US | 68.3 | 243 | 15 | 21 | 139 | 481 |
| E10 | conc. + US | 70.3 | 152 | | | | |
| CE2 | conc. by | 76.0 | Not mea- | | | | |
| | osmosis | | surable | | | | |
| | | | (>200000) | | | | |

TABLE 3
Green Body Characterization Data

| Sus- | | | | | | |
|---|---|---|---|---|---|---|
| pen- | Yttria | Solid | | Green | Green | Pore diameter |
| sion | mol % | loading | EF | density | opacity | (Average/Median) |
| E4 | 3 | 70.3 | | | 30 | |
| E6 | 3 | 69.9 | 1.22 | 54.5% | | |
| E7 | 3 | 60.0 | 1.23 | 53.5% | | |
| E8 | 3 | 65.2 | 1.22 | 54.6% | | |
| E10 | 3 | 70.3 | 1.22 | 54.9% | 30 | 4.46/3.64 |
| E13 | 4.5 | 70.2 | 1.21 | 55.9% | | 4.65/4.55 |
| E13 | 4.5 | 70.2 | 1.22 | 55.2% | | 4.49/4.52 |
| CE2 | 3 | 76.0 | 1.25 | 51.3% | | |

TABLE 4
Process Details and Properties of Sintered Parts

| | | | | | Peak | | | | | |
|---|---|---|---|---|---|---|---|---|---|---|
| | | | | Peak sinter | sinter | | Fracture | | | Grain |
| Sample | Suspension | Solid | Yttria | temp (deg | hold | Hardness | Toughness | | Millability | Size |
| ID | ID | Loading | mol % | C.) | (hour) | (GPa) | (MPa · m^{-.5}) | Opacity | Number | (nm) |
| CE3 | NA | NA | 3 | 1580 | 2.5 | 12.5 | 5 | 66.3 | 34 | |
| CE4 | NA | NA | 4 | 1580 | 2.5 | 12.5 | 3.5 | 64.3 | 57 | |
| CE5 | NA | NA | 5.3 | 1530 | 2.5 | 12.5 | 2.4 | 62.0 | 75 | |
| E7.1 | E7 | 60.0 | 3 | 1100 | 10 | | | 67.8 | | |
| E8.1 | E8 | 65.0 | 3 | 1100 | 10 | | | 64.4 | | |
| E10.1 | E10 | 70.3 | 3 | 1100 | 10 | | | 60.1 | | |
| CE2.1 | CE2 | 76.0 | 3 | | | | | 64.1 | | |
| E6.1 | E6 | 69.9 | 3 | 1175 | 1 | 13.1 | 4.16 | 64.6 | 50 | |
| E6.2 | E6 | 69.9 | 3 | 1200 | 1 | 13.1 | 4.14 | 66.0 | 50 | |
| E6.3 | E6 | 69.9 | 3 | 1225 | 1 | 13.1 | 4.12 | 68.3 | 51 | |
| E6.4 | E6 | 69.9 | 3 | 1250 | 1 | 12.9 | 4.2 | | 49 | |
| E6.5 | E6 | 69.9 | 3 | 1350 | 1 | | | | | |
| E6.6 | E6 | 69.9 | 3 | 1075 | 10 | 13.3 | 4.36 | 62.1 | 48 | |
| E6.7 | E6 | 69.9 | 3 | 1100 | 10 | 13.4 | 4.3 | 60.3 | 50 | 104 |
| E6.8 | E6 | 69.9 | 3 | 1125 | 10 | 13.2 | 4.14 | 64.5 | 51 | |
| E6.9 | E6 | 69.9 | 3 | 1150 | 10 | 13.0 | 4.23 | 65.9 | 49 | |
| E11.1 | E11 | 70.2 | 3.5 | 1175 | 1 | 13.4 | 3.63 | 61.3 | 59 | |
| E11.2 | E11 | | 3.5 | 1200 | 1 | 13.4 | 3.62 | 62.3 | 59 | |
| E11.3 | E11 | | 3.5 | 1225 | 1 | 13.3 | 3.65 | 64.1 | 58 | |
| E11.4 | E11 | | 3.5 | 1250 | 1 | 13.1 | 3.56 | 66.0 | 59 | |
| E11.5 | E11 | | 3.5 | 1075 | 10 | 13.6 | 3.77 | 59.7 | 58 | |
| E11.6 | E11 | | 3.5 | 1100 | 10 | 13.6 | 3.71 | 54.7 | 59 | |
| E11.7 | E11 | | 3.5 | 1125 | 10 | 13.4 | 3.66 | 59.9 | 59 | |
| E11.8 | E11 | | 3.5 | 1150 | 10 | 13.2 | 3.83 | 62.3 | 55 | |
| E12.1 | E12 | 70.1 | 4 | 1175 | 1 | 13.6 | 3.14 | | 67 | |
| E12.2 | E12 | | 4 | 1200 | 1 | 13.4 | 3.12 | | 67 | |
| E12.3 | E12 | | 4 | 1225 | 1 | 13.4 | 3.14 | | 66 | |
| E12.4 | E12 | | 4 | 1250 | 1 | 13.3 | 3.2 | | 65 | |
| E12.5 | E12 | | 4 | 1075 | 10 | 13.7 | 3.29 | 60.1 | 65 | |
| E12.6 | E12 | | 4 | 1100 | 10 | 13.8 | 3.22 | 52.8 | 66 | |
| E12.7 | E12 | | 4 | 1125 | 10 | | | 54.9 | | |
| E12.8 | E12 | | 4 | 1150 | 10 | 13.3 | 3.23 | 57.1 | 65 | |
| E13.1 | E13 | 70.2 | 4.52 | 1175 | 1 | 12.9 | 2.94 | 53.5 | 67 | |
| E13.2 | E13 | | 4.52 | 1200 | 1 | 13.5 | 2.92 | 52.7 | 70 | 141 |
| E13.3 | E13 | | 4.52 | 1225 | 1 | 13.5 | 2.79 | 58.8 | 72 | |
| E13.4 | E13 | | 4.52 | 1250 | 1 | 13.4 | 2.9 | 61.5 | 70 | |
| E13.5 | E13 | | 4.52 | 1075 | 10 | 11.8 | 3.15 | 69.1 | 60 | |
| E13.6 | E13 | | 4.52 | 1100 | 10 | 13.4 | 3.03 | 55.7 | 68 | |
| E13.7 | E13 | | 4.52 | 1125 | 10 | 13.6 | 2.78 | 52.5 | 72 | |
| E13.8 | E13 | | 4.52 | 1150 | 10 | 13.4 | 2.97 | 58.1 | 69 | |

The process disclosed herein provide the ability to maintain the nano size for the particles in the suspension both after the initial concentration and the ultrasonication. Examples of the particle size distribution are shown in Table 5 below.

3Y

| | | Post | |
|---|---|---|---|
| Cumulative | As Received, | Concentration, | Post Concentration + |
| Distribution | 57% SL | 68.3% SL | Ultrasonication, 68.3% SL |
| (% less) | (nm) | (nm) | (nm) |
| 1 | 12 | 15 | 12 |
| 10 | 15 | 18 | 15 |
| 20 | 17 | 19 | 17 |
| 30 | 18 | 20 | 19 |
| 40 | 20 | 22 | 20 |
| 50 | 21 | 24 | 21 |
| 60 | 23 | 26 | 22 |
| 70 | 26 | 32 | 24 |
| 80 | 93 | 123 | 98 |
| 90 | 133 | 150 | 139 |
| 99 | 531 | 433 | 481 |

### Test Methods

### Particle Size

Particle size distributions were measured with a Brookhaven Instruments Corp. X-ray disk centrifuge analyzer. Samples were collected from the source suspension and kept agitated until measurement.

### Viscosity

Viscosity was calculated using Brookfield DV2T instrument. 0.5 mL of nano suspension was used for each measurement (in the highest viscosity case, 0.1 mL was used). 40Z spindle was used for low viscosity nano suspensions and 51z spindle was used for high viscosity nano suspension. Based on the viscosity of the suspension, RPM was chosen amongst 0.1,5 or 100. These RPMs were chosen so that for all measurements torque was between 20-80% (for accuracy of reading). Samples were tested for 10 mins, with average viscosities recorded at every 2 minutes. The average of these measurements was reported as the viscosity.

### Enlargement Factor and Green Density

Polished green samples of nominal thickness of 1.1-2 mm were sintered to an organic removal cycle followed by sintering to a peak temperature and hold of 1100° C.-10 h. The enlargement factor EF and the % green density were calculated as follows

$$E F = thickness of the green sample / thickness of the sintered \% Green density = 1 / ( E {F}^{3} )$$

### Pore Size

Pore size and pore size distributions determined by mercury porosimetry on 1-4 gram sample that had volatile removal at 350° C.-2h. Samples were dried before mercury intrusion. Intrusion was performed with a Micromeritics Autopore V porosimeter with set pressure ranges from total vacuum to 60,000 psi using Micromeritics penetrometers models #07 and #09. The average pore size and median pore diameter (volume) from the measurement were reported.

### Strength

Samples for three-point bend strength (flexural strength) testing were prepared according to ISO 6872:2015 for the preparation of strength testing for dental ceramic materials. Results are provided in MPa. Samples were cast in a mold of bar shape, dried and ground flat to a dimension corresponding to 1.68×25×4 mm³ after sintering using 1200 grit and 2000 grit SiC polishing paper until visually free of defects. The bars were subjected to volatile removal and sintering. After sintering, the central region of both the tensile and compressive surfaces were visually inspected for defects by optical microscope. The side with the fewest observed defects was chosen as the side broken in tension (face-down in the test fixture). Flexural testing was performed on a Shimadzu EZ-Test universal testing machine with a custom built three-point bend fixture according to ISO 6872. The bars were aligned on the two rollers using a metal guide. Flexural strengths were calculated via the measured breaking load and measured dimensions.

Fracture Toughness, Hardness and Millability Number Tabs of ceramic materials were milled out of a bisque block. The bisque tabs have the dimensions of approximately 13-15 mm, and thickness of 1-5 mm after sintering. Polishing was carried out to obtain a scratch-free surface. Tabs were polished at a force of 30 lbs, a head speed of 80 rpm and plate speed of 120 rpm on a series of polishing pads of specified grit size for specified duration in following sequence—80, 220, 500 and 1200 grit for 0.5-1 min, 1 min 7 min and 12 min respectively. The polishing was then completed by polishing at the same settings for 15 minutes each with 15 μm, 3 μm and 1 μm diamond suspensions and 0.06 μm silica suspension. The polished side with the fewest observed defects was chosen as the side for testing. Testing was performed on a Shimadzu Micro Hardness Tester (HMV-G21) testing machine with a Vickers indenter fixture. The length of the crack and indentation diagonal were measured by built in optical microscope (×10, ×40). The method of testing was based on Brian Lawn's calculation (1980) and G. R. Anstis (J. Am. Ceram. Soc., 64(9), P533-538, 1981). Using the equation:

$$Vickers hardness in GPa , H = 1.854 * ( P / {d}^{2} )$$

$$Fracture Toughness ( MPa \cdot {m}^{- 1 / 2} ) , {K}_{IC} = 0.0205 * [ 2 √ ( E / H ) ] * [ P / ( 3 / 2 √ C ) ]$$

wherein P is applied load (N): C: crack length from the center of the impression to the crack tip: d: the length of the indentation diagonal, E: Young's modulus (GPa)

(Hardness Measurement Ref.: Vander, G. F. (2000). Microindentation hardness testing according to H. Kuhn & D. Medlin (Eds.), ASM Handbook, Volume 8: Mechanical Testing and Evaluation (pp. 221-231). ASM International.)

The millability number was calculated using the equation

$$Millability Number = 111.72 - 193.77 \times ( {K}_{IC} / H )$$

### Opacity

Discs were ground flat to a thickness corresponding to 1 mm after sintering using 1200 grit and 2000 grit SiC polishing paper until visually free of defects. These were then subjected to volatile removal and sintering. The polished discs with the thickness of 1±0.1 mm were measured between the wavelength of 400 to 700 nm with a Konica-Minolta CM5 spectrophotometer at opacity mode (reflection mode: Specular Component type: SCI: Measurement area diameter=8 mm) illuminated by a D65 light source for all samples. Before test, the machine need to calibrated. The discs were tested under the white and dark background. The white background is using a white calibration tile (Avian Technologies LLC, FWT-99-02C). The dark background is using a zero calibration box (Konica Minolta. CM-A124). A minimum of two spectra were collected per sample and averaged to yield the final measured opacity.

### Translucency

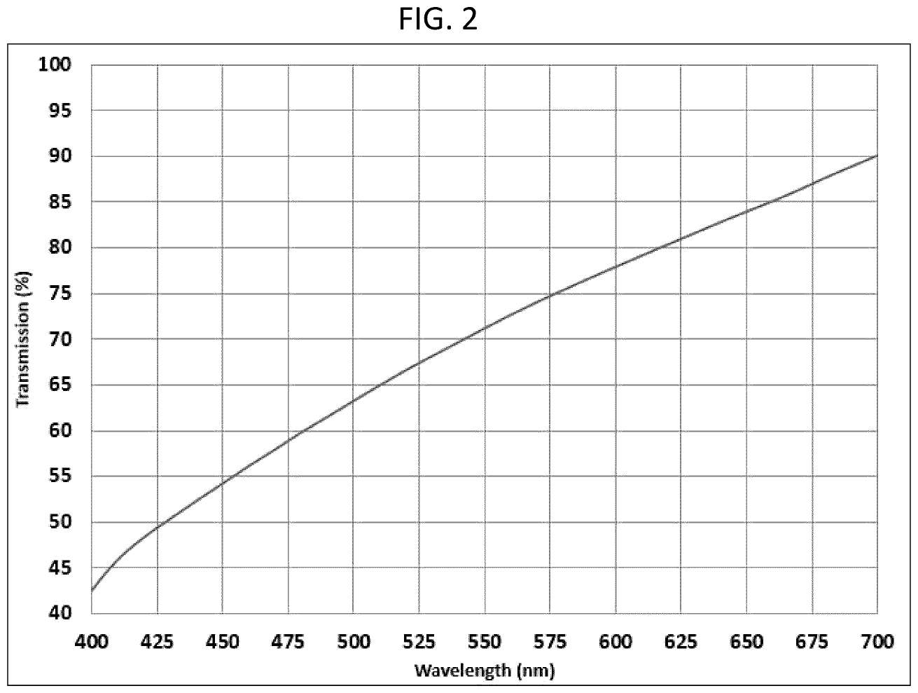

Green samples were ground flat until visually free of defects with 1200 and 2000 grit SiC polishing paper and to a thickness of 1.0 mm. Surface dust and debris was removed by blowing. Translucency spectra was collected by measuring the percent transmittance of a 1 mm thick sample between a wavelength of 360 to 740 nm using a Konica-Minolta CM5 spectrophotometer illuminated by a D65 light source. A representative translucency spectra for a green sample corresponding to Example 13 is shown in FIG. 2.

### Grain Size

Grain size measurements were performed on sintered materials as outlined in ASTM E112-10, Standard Test Method for Determining Average Grain Size. Sintered samples were polished to remove surface roughness, and thermally etched for 10 minutes in an oven heated to 1100° C., and a gold coating was applied to the etched samples. The samples were analyzed by FEI Magellan™ 400 Scanning Electron Microscope. The number of intercepts between grain boundaries intercepting either a horizontal or vertical line starting from the first discernable grain boundary on one end of the micrograph and ending at the last discernable grain boundary on the opposite end was collected. The line average intercept length for the line was determined by diving the length of the line by the number of intercepts. This process was performed for each micrograph at 200× for at least three horizontal line sweeps and three vertical line sweeps and at least a minimum of 30 total intercepts. Line Grain size was calculated by multiplying the average intercept length by a proportionality constant of 1.56 for each line. The resulting line grain sizes from the different lines were then averaged to determine the grain size

In view of the many possible embodiments to which the principles of the disclosed invention may be applied, it should be recognized that the illustrated embodiments are only preferred examples of the invention and should not be taken as limiting the scope of the invention.

What is claimed is:

1. A sintered ceramic body comprising:
a sintered yttria-stabilized zirconia ceramic material, stabilized by 3 mol % to 4.8 mol % yttria, wherein the sintered ceramic material has an opacity of 52% to 65% (when measured on a 1 mm thick fully sintered ceramic body), an average grain size of less than 175 nm, a fracture toughness greater than 2.5 MPa·m^{1/2} and a millability number<75.

2. The sintered ceramic body of claim 1, wherein the material has a fracture toughness greater than 2.8 MPa·m^{1/2}.

3. The sintered ceramic body of claim 1, wherein the material has a relative density of greater than 98%.

4. The sintered ceramic body of claim 1, wherein the material has an opacity of 59% to 63%.

5. The sintered ceramic body of claim 1, wherein the material has an average grain size of less than 120 μm.

6. The sintered ceramic body of claim 1, wherein the material has a millability number of <60.

7. The sintered ceramic body of claim 1, wherein the material has a millability number of <50 and an opacity of 60% to 63%.

8. The sintered ceramic body of claim 1, wherein the material has a hardness value of 11.8 to 13.8 GPa.

9. The sintered ceramic body of claim 1, wherein the material has a millability number of 64 to 74 and an opacity of 52% to 59%.

10. A method comprising:
concentrating an initial nano zirconia aqueous suspension resulting in a first intermediate nano zirconia aqueous suspension having a higher viscosity and solids content relative to the initial nano zirconia aqueous suspension:
lowering the viscosity of the first intermediate nano zirconia aqueous suspension, while maintaining the solids content, resulting in a second intermediate nano zirconia aqueous suspension having a lower viscosity relative to the first intermediate nano zirconia aqueous suspension; and
casting the second intermediate nano zirconia aqueous suspension that comprises allowing the second intermediate nano zirconia aqueous suspension to increase in viscosity and drying the nano zirconia aqueous suspension under ambient conditions resulting in a green state body,
wherein the method does not include adding a pH modifier, or wherein the method does not include adding an anionic dispersant.

11. The method of claim 10, wherein the initial nano zirconia aqueous suspension has an yttria concentration of 2 to 8 mol %, a solids content of 20 to 57%, and a viscosity of 5 to 100 Cp.

12. The method of claim 10, wherein the casting of the second intermediate nano zirconia aqueous suspension comprises thickening of the second intermediate nano zirconia aqueous suspension.

13. The method of claim 10, wherein the casting of the second intermediate nano zirconia aqueous suspension comprises allowing the second intermediate nano zirconia aqueous suspension to reach a viscosity over 8000 cP, wherein the cast part can support its own weight without deformation at ambient conditions.

14. The method of claim 10, wherein the first intermediate nano zirconia aqueous suspension has a solids content of 68 to 72% solids, and the second intermediate nano zirconia aqueous suspension has a solids content of 68 to 72% solids.

15. The method of claim 10, wherein the first intermediate nano zirconia aqueous suspension reaches a viscosity over 8000 cP.

16. The method of claim 10, wherein the second intermediate nano zirconia aqueous suspension has a viscosity of 20 to 300 cP prior to the casting.

17. The method of claim 10, wherein each of the initial nano zirconia suspension, the first intermediate nano zirconia suspension, and the second intermediate nano zirconia suspension comprises yttria-stabilized particles having a particle size distribution at D₍₅₀₎ of less than 50 nm.

18. The method of claim 10, further comprising sintering the green state body by subjecting the green state body to a temperature of less than 1250° C. resulting in a sintered ceramic body.

19. The method of claim 18, wherein the sintered ceramic body has an opacity of 52% to 65% (when measured on a 1 mm thick fully sintered ceramic body), an average grain size of less than 150 nm, a fracture toughness greater than 2.5 MPa·m^{1/2} and a millability number<75.

20. A method comprising:
concentrating an initial nano zirconia aqueous suspension resulting in a first intermediate nano zirconia aqueous suspension having a higher viscosity and solids content relative to the initial nano zirconia aqueous suspension, wherein the first intermediate nano zirconia aqueous suspension has a solids content of 68 to 72% solids and a viscosity of over 8000 cP:
lowering the viscosity of the first intermediate nano zirconia aqueous suspension, while maintaining the solids content, resulting in a second intermediate nano zirconia aqueous suspension having a lower viscosity relative to the first intermediate nano zirconia aqueous suspension wherein the second intermediate nano zirconia aqueous suspension has a solids content of 68 to 72% solids and a viscosity of 100 to 300 cP; and
casting the second intermediate nano zirconia aqueous suspension that comprises allowing the second intermediate nano zirconia aqueous suspension to reach a viscosity of over 8000 cp wherein the cast part can support its own weight without deformation at ambient conditions, and drying the nano zirconia aqueous suspension under ambient conditions resulting in a green state body,
wherein the green state body has a green density of >53% and median pore size of less than 10 nm, and wherein each of the initial nano zirconia suspension, the first intermediate nano zirconia suspension, and the second intermediate nano zirconia suspension comprises yttria-stabilized particles having a particle size distribution at D(so) of less than 50 nm.
